(19) United States
(12) Patent Application Publication
(10) Pub. No.: US 2017/0163753 A1
(43) Pub. Date: Jun. 8, 2017

(54) METHOD AND APPARATUS FOR CONTROLLING PLAY DEVICE TO PLAY VIDEO

(71) Applicants: LE HOLDINGS (BEIJING) CO., LTD., Beijing (CN); LE SHI ZHI XIN ELECTRONIC TECHNOLOGY (TIANJIN) LIMITED, Tianjin (CN)

(72) Inventor: Zhen Li, Tianjin (CN)

(21) Appl. No.: 15/248,397

(22) Filed: Aug. 26, 2016

Related U.S. Application Data
(63) Continuation of application No. PCT/CN2016/088891, filed on Jul. 6, 2016.

(30) Foreign Application Priority Data
Dec. 4, 2015 (CN) 201510884371.5

(51) Int. Cl. H04L 29/08; H04L 29/06; H04L 29/12

(52) U.S. Cl. CPC H04L 67/26; H04L 67/02; H04L 61/2007; H04L 65/60; H04N 21/4782

(57) ABSTRACT

An embodiment of the present disclosure discloses a method and apparatus for controlling a play device to play a video, wherein the method includes: acquiring an IP address corresponding to the play device and a webpage pushing address by a mobile terminal through scanning a two-dimensional code displayed on the play device; loading a pushing webpage corresponding to the webpage pushing address by the mobile terminal, wherein the pushing webpage comprises a plurality of piece of video information; and acquiring a pushing request triggered specific to one piece of selected video information to be pushed and sending the pushing request to the play device according to the IP address, by the mobile terminal, so that the play device plays a video corresponding to the video information to be pushed according to the pushing request.

### CROSS-REFERENCE TO RELATED APPLICATIONS

The present disclosure is a continuation of International Application No. PCT/CN2016/088891 filed on Jul. 6, 2016, which is based upon and claims priority to Chinese Patent Application No. 201510884371.5, entitled “METHOD AND APPARATUS FOR CONTROLLING PLAY DEVICE TO PLAY VIDEO”, filed Dec. 4, 2015, the entire contents of all of which are incorporated herein by reference.

### TECHNICAL FIELD

The present disclosure generally relates to the technical field of play devices, and in particular to a method and apparatus for controlling a play device to play a video.

### BACKGROUND

With the rapid development of multimedia technology, a user may watch a variety of videos via various play devices. With a smart television as an example, the smart television is a smart play device turning up by following the trends of high definition, networking and intellectualization, and has the functions of acquiring program contents from various channels such as the Internet and a computer and clearly presenting contents mostly needed by a consumer with a simple and easy-to-use integrated operation interface. Compared with an application platform of a traditional television, the smart television may provide various application services such as network searching, network television, on-demand video playing, digital music, network news, and network video calls.

In the prior art, there are mainly two means of controlling a play device to play a video, the first one is to select a video in the play device by a remote controller matched with the play device for playing; and the second one is to install a client application for pushing a video to the play device on a smart mobile terminal, wherein a user may select a video to be watched and push it to the play device, which may play the pushed video.

However, in the process of implementing the present disclosure, the inventor has found that the following problems at least exist in the prior art: for the first means of selecting the video with the remote controller as described above, the speed of video searching is low, thereby being low in efficiency and reducing the use experience of the user; for the second means of pushing the video by the client application to the play device, it is only applicable to the smart mobile terminal, and a non-smart mobile terminal may not push the video to the play device, thereby being poor in universality; and moreover, a relevant client application needs to be installed on the smart mobile terminal, which will occupy the memory space of the smart mobile terminal.

### SUMMARY

The present disclosure discloses a method and apparatus for controlling a play device to play a video so as to solve the problems of poor universality and the occupation of the memory space of the mobile terminal with respect to the means of pushing the video through the mobile terminal to the play device in the prior art.

To solve the problem above, an embodiment of the present disclosure discloses a method for controlling a play device to play a video, including the following steps:

acquiring an IP address corresponding to the play device and a webpage pushing address by a mobile terminal through scanning a two-dimensional code displayed on the play device;

loading a pushing webpage corresponding to the webpage pushing address by the mobile terminal, wherein the pushing webpage comprises a plurality of pieces of video information;

acquiring a pushing request triggered specific to one piece of selected video information to be pushed and sending the pushing request to the play device according to the IP address, by the mobile terminal, so that the play device plays a video corresponding to the video information to be pushed according to the pushing request.

Correspondingly, an embodiment of the present disclosure discloses a method for controlling a play device to play a video, including:

displaying a two-dimensional code by the play device so that a mobile terminal acquires an IP address corresponding to the play device and a webpage pushing address through scanning the two-dimensional code, and loading the pushing webpage corresponding to the webpage pushing address, wherein the pushing webpage comprises a plurality of pieces of video information;

receiving a pushing request sent by the mobile terminal by the play device, wherein the pushing request is a request acquired by the mobile terminal and triggered specific to one piece of selected video information to be pushed, and is sent to the play device according to the IP address;

playing a video corresponding to the video information to be pushed according to the pushing request by the play device.

An embodiment of the present disclosure discloses an electronic device for controlling a play device to play a video, including at least one first processor; and a first memory communicably connected with the at least one first processor for storing instructions executable by the at least one first processor, wherein execution of the instructions by the at least one first processor causes the at least one first processor to:

acquire an IP address corresponding to the play device and a webpage pushing address through scanning a two-dimensional code displayed on the play device;

load a pushing webpage corresponding to the webpage pushing address, wherein the pushing webpage comprises a plurality of pieces of video information;

acquire a pushing request triggered specific to one piece of selected video information to be pushed and send the pushing request to the play device according to the IP address, so that the play device plays a video corresponding to the video information to be pushed according to the pushing request.

An embodiment of the present disclosure discloses an electronic device, comprising at least one second processor; and a second memory communicably connected with the at least one second processor for storing instructions executable by the at least one second processor, wherein execution of the instructions by the at least one second processor causes the at least one second processor to:

display a two-dimensional code so that a mobile terminal acquires an IP address corresponding to the electronic device and a webpage pushing address through scanning the two-dimensional code, and load the pushing webpage corresponding to the webpage pushing address, wherein the pushing webpage comprises a plurality of pieces of video information;

receive a pushing request sent by the mobile terminal, wherein the pushing request is a request acquired by the mobile terminal and triggered specific to one piece of selected video information to be pushed, and is sent to the electronic device according to the IP address;

play a video corresponding to the video information to be pushed according to the pushing request.

An embodiment of the present disclosure discloses a computer program, comprising computer readable codes, wherein the operating of the computer readable codes on a mobile terminal leads to that the mobile terminal executes the method for controlling the play device to play the video above.

An embodiment of the present disclosure discloses a computer program, comprising computer readable codes, wherein the operating of the computer readable codes on a play device leads to that the play device executes the method for controlling the play device to play the video above.

An embodiment of the present disclosure discloses a computer readable medium, in which the computer program above is stored.

### BRIEF DESCRIPTION OF THE DRAWINGS

In order to more clearly illustrate the technical solution in an embodiment of the present disclosure or the prior art, drawings required to be used in the description of the embodiment or the prior art will be briefly introduced in the following; and it is obvious that the drawings described in the following are only related to some embodiments of the present disclosure. A person skilled in the art without undertaking creative work may obtain other drawings according to these drawings.

FIG. 1 is a flowchart of the steps of a method for controlling a play device to play a video according to some embodiments of the present disclosure.

FIG. 2 is a flowchart of the steps of a method for controlling a play device to play a video according to a some embodiments of the present disclosure.

FIG. 3 is a flowchart of the steps of a method for controlling a play device to play a video according to a some embodiments of the present disclosure.

FIG. 4 is a block diagram of a structure of an apparatus for controlling a play device to play a video according to some embodiments of the present disclosure.

FIG. 5 is a block diagram of a structure of an apparatus for controlling a play device to play a video according to some embodiments of the present disclosure.

FIG. 6 shows schematically a block diagram of an electronic device for executing a method according to some embodiments of the present disclosure.

FIG. 7 shows schematically a storage unit for maintaining or carrying program codes for implementing a method according to some embodiments of the present disclosure.

### DETAILED DESCRIPTION

For the purpose of making objects, technical solutions and advantages of embodiments of the present disclosure more clear, clear and complete description will be made to technical solutions of the present disclosure in conjunction with corresponding drawings in the embodiment of the present disclosure. Obviously, the described embodiments are merely a part of the embodiments of the present disclosure and not all the embodiments. Based on the embodiments of the present disclosure, all other embodiments obtained by a person skilled in the art without undertaking creative work fall within the protection scope of the present disclosure.

### Embodiment 1

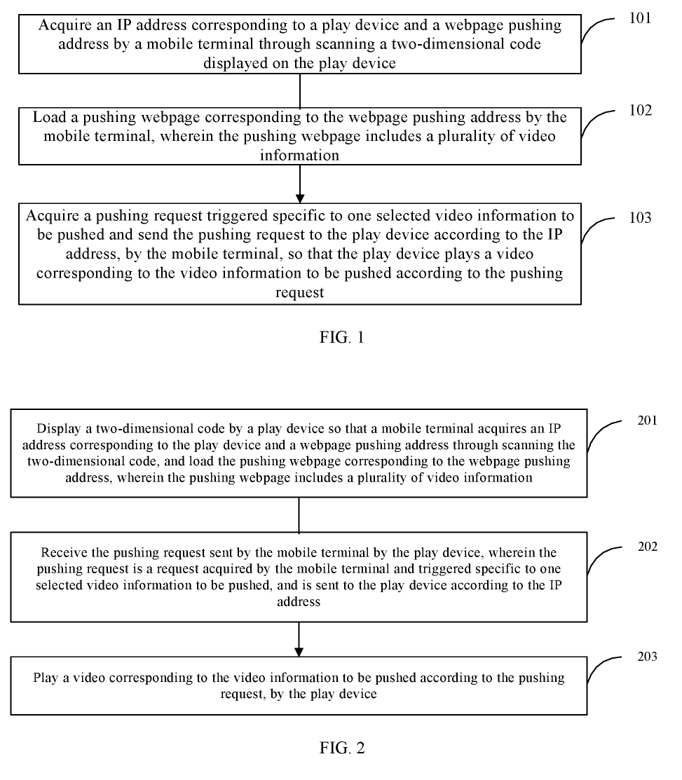

With reference to FIG. 1, it shows a flowchart of the steps of a method for controlling a play device to play a video of Embodiment 1 of the present disclosure.

A method for controlling a play device to play a video of the embodiment of the present disclosure includes the steps as follows.

Step 101, acquire an IP address corresponding to the play device and a webpage pushing address by a mobile terminal through scanning a two-dimensional code displayed on the play device.

In the embodiment of the present disclosure, the mobile terminal may be either a smart mobile terminal (such as a smart mobile phone and a tablet computer) or a non-smart mobile terminal (such as a non-smart mobile phone) as long as the mobile terminal can scan a two-dimensional code, and an application for pushing a video to the play device does not need to be installed on the mobile terminal.

In the embodiment of the present disclosure, the play device may be a smart television and other devices. The play device corresponds to a self IP (Internet Protocol) address and a pushing webpage for pushing a video to the play device, wherein the IP address is used for communication between the mobile terminal and the play device, the pushing webpage corresponds to a webpage pushing address, and by executing a relevant action on the pushing webpage, a video corresponding to video information provided on the pushing webpage may be pushed to the play device for playing.

The IP address and webpage pushing address as described above, corresponding to the play device, may be saved in the form of a two-dimensional code, the play device can display the corresponding two-dimensional code, and the mobile terminal may acquire the IP address corresponding to the play device and the webpage pushing address through scanning the two-dimensional code displayed on the play device. The two-dimensional code, as a black and white graph in which a specific geometric graph distributes on a plane (in a two-dimensional direction) according to a certain law, serves as a key to all information data. In modern commercial activities, it has a very broad range of applications, such as product anti-counterfeiting/traceability, advertisement pushing, website link, data loading, commodity transaction, location/navigation, electronic certificate, vehicle management, information transmission, name card exchanging, and WIFI sharing. The two-dimensional code displayed by the play device may include various information related to the play device, wherein the IP address corresponding to the play device and the webpage pushing address are included. Alternatively, the mobile terminal first scans the two-dimensional code displayed on a display interface of the play device to obtain the information of the two-dimensional code after scanning, and then analyzes the obtained information of the two-dimensional code to thereby obtain the IP address corresponding to the play device and the webpage pushing address. Thereunto, the mobile terminal can be provided with two-dimensional code scanning software, with which the two-dimensional code on the play device is scanned, in advance, the mobile terminal can also be provided with other software having a two-dimensional scanning function in advance, with which the two-dimensional code on the play device can be scanned, and the embodiment of the present disclosure does not set a limit to this. For the specific process of obtaining the two-dimensional code by scanning the same, a person skilled in the art may perform relevant processing according actual experience, and the embodiment of the present disclosure will not discuss it in detail here.

Step 102, load a pushing webpage corresponding to the webpage pushing address by the mobile terminal, wherein the pushing webpage includes a plurality of pieces of video information.

The mobile terminal may automatically load the pushing webpage corresponding to the webpage pushing address described above after acquiring the webpage pushing address corresponding to the play device.

Alternatively, in the embodiment of the present disclosure, the webpage pushing address may be the IP address of the pushing webpage, and the form of the address may be in the form of the IP address of the play device plus a space domain name of the pushing webpage. The pushing webpage corresponding to the play device may be a webpage in the form of HTML (Hyper Text Markup Language), the page information corresponding to the pushing webpage may be saved in the play device in advance, and the page information and the webpage pushing address are saved in correspondence.

Therefore, Step 102 may include the substeps as follows.

Substep a1, start a preset browser and send a page request carrying the webpage pushing address to the play device through the browser, by a mobile terminal, so that the play device acquires corresponding page information according to the webpage pushing address and returns the page information to the mobile terminal.

The mobile terminal may load the pushing webpage through the browser, to be specific, first, the mobile terminal automatically starts the preset browser, wherein the preset browser may be a browser installed on the mobile terminal or a browser having a browser core for any application; then, the mobile terminal sends the page request carrying the webpage pushing address to the play device through the browser; and since the webpage pushing address and the corresponding page information thereof are saved in the play device, the play device may acquire the corresponding page information according to the webpage pushing address after obtaining the webpage pushing address by analyzing the page request, and return the page information to the mobile terminal.

Alternatively, in the embodiment of the present disclosure, it is also possible to pre-create a server corresponding to the play device; the server may be a software application in terms of implementation; the page information corresponding to the above pushing webpage is saved in the server; the play device may send the page request to the server after receiving the page request sent by the mobile terminal; and the server analyzes the page request to obtain the webpage pushing address, acquires the corresponding page information and then returns the page information to the mobile terminal.

Substep a2, receive the page information returned by the play device, generate a pushing webpage corresponding to the webpage pushing address by adopting the page information and load the pushing webpage.

The page information returned by the play device may include page layout, page content, page size and other information, the mobile terminal may generate the pushing webpage corresponding to the webpage pushing address by adopting the page information after receiving the page information, and the pushing webpage may be loaded after being generated, that is, the pushing webpage is displayed on the interface of the mobile terminal.

Step 103, acquire a pushing request triggered specific to one selected video information to be pushed and send the pushing request to the play device according to the IP address, by the mobile terminal, so that the play device plays a video corresponding to the video information to be pushed according to the pushing request.

The pushing webpage includes a plurality of pieces of video information, which may include a video name, a video address and the like, and the pushing webpage may display this video information in the form of a list. When a user wants to push a video to the play device, the user may perform a relevant operation on the pushing webpage displayed by the mobile terminal to trigger the pushing request; for example, when the user clicks a certain video information, the pushing webpage may display a prompt box carrying the characters of “pushing”; the user may trigger the pushing request after clicking the prompt box; and the video information to be pushed specific to the pushing request is the above video information clicked by the user.

Alternatively, the process of acquiring the pushing request triggered with respect to the selected video information to be pushed by the mobile terminal in Step 103 includes selecting the video information to be pushed by the mobile terminal; and generating a pushing request carrying a pushing instruction and the video information to be pushed according to a set protocol. Alternatively, for example, the server of the above set protocol can be pre-created in the play device as in the above embodiment of the present disclosure, for example, the server may be an HTTP (Hyper Text Transfer Protocol) server, which may be created based on an Android television platform, and can analyze the request of the corresponding protocol sent by the mobile terminal. Therefore, the set protocol above may be HTTP, i.e. the pushing request is an HTTP request, and a communication between the mobile terminal and the play device is in the form of an HTTP request. It should be noted that, in the embodiment of the present disclosure, the set protocol above is not limited to HTTP, a person skilled in the art may adopt any other applicable protocols, such as, Web Socket protocol (which is a new protocol of HTML5 for realizing the full duplex communication between the browser and the server), as long as the server corresponding to the protocol is created in the play device.

After acquiring the IP address of the play device through scanning the two-dimensional code on the play device, the mobile terminal may perform communication connection with the play device according to the IP address, therefore, the mobile terminal sends the pushing request to the play device according to the IP address corresponding to the play device after acquiring the pushing request. Alternatively, the mobile terminal may send the pushing request to the pre-created server of the set protocol in the play device through the browser. After receiving the pushing request, the play device plays a video corresponding to the video information to be pushed according to the pushing request, and the specific playing process of the play device will be described in detail in the embodiment 2 below.

According to the method for controlling the play device to play the video provided by the embodiment of the present disclosure, the mobile terminal may acquire the IP address corresponding to the play device and the webpage pushing address by scanning the two-dimensional code displayed on the play device, and then may load the pushing webpage corresponding to the webpage pushing address, wherein the pushing webpage includes a plurality of pieces of video information; when needing to watch the video, a user may select one piece of video information to be pushed for pushing; and the mobile terminal sends the pushing request to the play device according to the IP address so that the play device plays the video corresponding to the video information to be pushed according to the pushing request. As can be known, according to the embodiment of the present disclosure, a relevant client application does not need to be installed in a mobile terminal, therefore, the memory space of the mobile terminal cannot be occupied due to installation of the application, and in addition, for both a non-smart mobile terminal and a smart mobile terminal, videos can be pushed to the play device, thereby achieving high university.

### Embodiment 2

With reference to FIG. 2, it shows a flowchart of the steps of a method for controlling a play device to play a video of Embodiment 2 of the present disclosure.

A method for controlling a play device to play a video of the embodiment of the present disclosure includes the steps as follows.

Step 201, display a two-dimensional code by the play device so that a mobile terminal acquires an IP address corresponding to the play device and a webpage pushing address through scanning the two-dimensional code, and load the pushing webpage corresponding to the webpage pushing address, wherein the pushing webpage includes a plurality of pieces of video information.

In the embodiment of the present disclosure, it is possible to generate the two-dimensional code corresponding to the play device in advance, wherein an IP address corresponding to the play device, a webpage pushing address and other relevant information are saved in the two-dimensional code, that is, the two-dimensional code is generated according to the IP address corresponding to the play device and the webpage pushing address corresponding to the play device, for example, the two-dimensional code may be generated by using an open-source code; for the specific generation process of the two-dimensional code, a person skilled in the art may perform relevant processing according to actual experience; and the embodiment of the present disclosure will not discuss it in detail here. The generated two-dimensional code as described above is saved in the play device, which has a two-dimensional code display page for displaying the two-dimensional code, when a user selects to enter the two-dimensional code display page, the two-dimensional code may be displayed in the page so as to be scanned by the mobile terminal. Thereunto, the two-dimensional code display page may be either an original page of the play device or a page individually generated for specially displaying the two-dimensional code, and the embodiment of the present disclosure sets no limitation to this.

Further, the embodiment of the present disclosure considers that the IP address corresponding to the play device may be changed; for example, the corresponding IP address of the play device will be changed after manual switching of a network cable interface of the play device, therefore, the changed IP address cannot be acquired with the saved original two-dimensional code under such circumstances, and it is necessary to generate a new two-dimensional code carrying the changed IP address. Therefore, alternatively, before displaying the two-dimensional code by the play device in the embodiment of the present disclosure, the method may also include the steps as follows.

Step 1, identify whether a two-dimensional code needs to be regenerated or not when the play device detects the entry in a two-dimensional code display page; and if yes, execute Step 2, and if not, execute Step 3.

Thereunto, the process of identifying whether a two-dimensional code needs to be regenerated or not may include: acquiring an IP address currently corresponding to the play device; determining whether the currently corresponding IP address is the same as an IP address included in the saved original two-dimensional code; if yes, identifying that the two-dimensional code does not need to be regenerated, and if not, identifying that the two-dimensional code needs to be regenerated.

Step 2, if yes, generate a new two-dimensional code according to an IP address corresponding to the play device currently and a webpage pushing address.

After generating the new two-dimensional code, the two-dimensional code, which is the new two-dimensional code, is displayed by the play device, to be specific, the new two-dimensional code is displayed in the two-dimensional code display page.

Step 3, if not, acquire an original two-dimensional code saved.

After acquiring the original two-dimensional code saved, the play device displays the two-dimensional code, which is the original two-dimensional code; to be specific, the original two-dimensional code is displayed in the two-dimensional code display page.

Step 202, receive a pushing request sent by the mobile terminal by the play device, wherein the pushing request is a request acquired by the mobile terminal and triggered specific to one piece of selected video information to be pushed, and is sent to the play device according to the IP address.

The mobile terminal acquires the IP address corresponding to the play device and the webpage pushing address through scanning the two-dimensional code, and loads the pushing webpage corresponding to the webpage pushing address, wherein the pushing webpage includes a plurality of pieces of video information; and a request triggered specific to the video information to be pushed can be triggered on the mobile terminal by performing relevant operation on the pushing webpage, and the mobile terminal sends the pushing request to the play device according to the IP address. Relevant description as described in Embodiment 1 can be referred to for the specific process.

Step 203, play a video corresponding to the video information to be pushed according to the pushing request by the play device.

As described in Embodiment 1, the server of the set protocol can be pre-created in the play device in the embodiment of the present disclosure; and the pushing request as described above is a request generated by the mobile terminal according to the set protocol, therefore, the server may analyze the pushing request to obtain information carried therein. Therefore, alternatively, Step 203 may include the following substeps:

Substep b1, send the pushing request to a pre-created server of a set protocol in the play device by the play device, and analyze the pushing request by the server according to the set protocol to obtain a pushing instruction and the video information to be pushed, carried in the pushing request.

With the HTTP server as an example, the pushing request sent by the mobile terminal is an HTTP request, and the HTTP server may analyze the pushing request according to the HTTP protocol; the process of analyzing the pushing request according to the HTTP protocol may include header analysis and body analysis, wherein the body analysis may specifically include PUT code analysis and Post code analysis; and for the specific analysis process, the embodiment of the present disclosure will not discuss it in detail here.

Substep b2, respond to the pushing instruction and start a preset player to play a video corresponding to the video information to be pushed, by the server.

The pushing request, obtained after the HTTP server analyzes the pushing request, carries a pushing instruction and the video information to be pushed, wherein the pushing instruction is used for indicating an action (i.e. a video playing action) to be executed, and the HTTP server may start the preset player to play the video corresponding to the video information to be pushed just by responding to the pushing instruction. Specifically, the HTTP server can call for an API (Application Programming Interface) of the player as descried above, and transmits the video information to be pushed to the player through the API; the video information to be pushed may include the name/address and other information of a video information to be pushed; and the player finds out a corresponding video in a video resource server corresponding to the play device according to the video information, and plays the video after acquiring the resource of the video.

According to the embodiment of the present disclosure, a relevant client application does not need to be installed in a mobile terminal, therefore, the memory space of the mobile terminal cannot be occupied due to the installation of the application, and in addition, for both a non-smart mobile terminal and a smart mobile terminal, videos can be pushed to the play device, thereby achieving high university.

### Embodiment 3

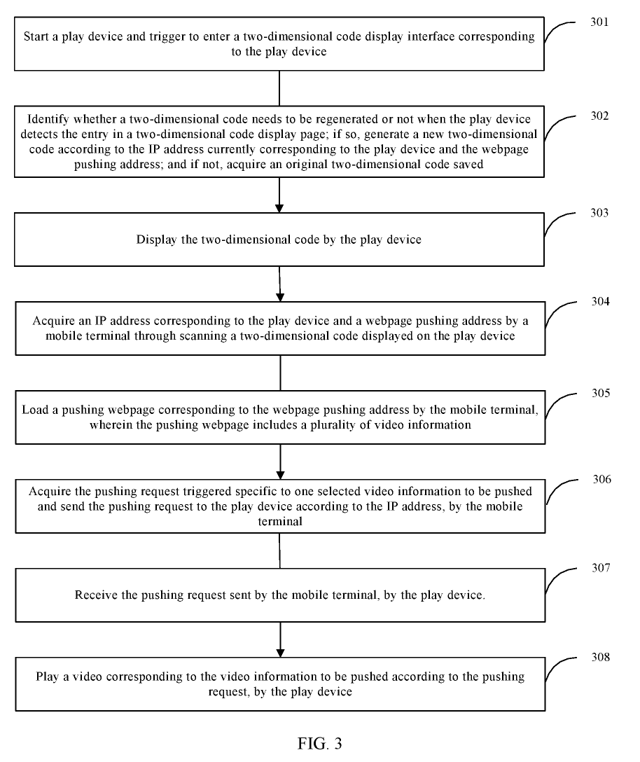

With reference to FIG. 3, it shows a flowchart of the steps of a method for controlling a play device to play a video Embodiment 3 of the present disclosure.

A method for controlling a play device to play a video of the embodiment of the present disclosure includes the steps as follows.

Step 301, start the play device and trigger and enter a two-dimensional code display interface corresponding to the play device.

Step 302, identify whether a two-dimensional code needs to be regenerated or not when the play device detects the entry in a two-dimensional code display page; and if yes, generate a new two-dimensional code according to the IP address currently corresponding to the play device and the webpage pushing address; and if not, acquire an original two-dimensional code saved.

Step 303, display the two-dimensional code by the play device.

Step 304, acquire an IP address corresponding to the play device and a webpage pushing address by a mobile terminal through scanning a two-dimensional code displayed on the play device.

Step 305, load a pushing webpage corresponding to the webpage pushing address by the mobile terminal, wherein the pushing webpage includes a plurality of pieces of video information.

Step 306, acquire a pushing request triggered specific to one piece of selected video information to be pushed and send the pushing request to the play device according to the IP address, by the mobile terminal.

Step 307, receive a pushing request sent by the mobile terminal, by the play device.

Step 308, play a video corresponding to the video information to be pushed according to the pushing request by the play device.

For the specific process of each of the steps as described above, refer to relevant descriptions in Embodiment 1 and Embodiment 2 as described above, and the embodiment of the present disclosure will not discuss it in detail here.

For the sake of simplicity in description, the foregoing method embodiments are described as a series of act combinations, however, a person skilled in the art shall be informed that the present disclosure is not limited by the described ordering of acts, as some steps could, in accordance with the present disclosure, occur in other orders or concurrently. Further, a person skilled in the art shall also be informed that the embodiments as described in the Description are preferred embodiments, in which the acts and modules involved are not necessarily required by the present disclosure.

### Embodiment 4

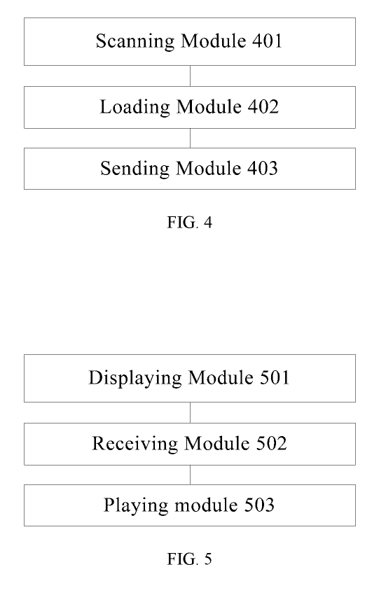

With reference to FIG. 4, it shows a block diagram of a structure of an apparatus for controlling a play device to play a video Embodiment 4 of the present disclosure.

An apparatus for controlling a play device to play a video of the embodiment of the present disclosure is an apparatus in a mobile terminal and includes the following modules:

a scanning module 401 for acquiring an IP address corresponding to the play device and a webpage pushing address through scanning a two-dimensional code displayed on the play device;

a loading module 402 for loading a pushing webpage corresponding to the webpage pushing address, wherein the pushing webpage includes a plurality of pieces of video information;

a sending module 403 for acquiring a pushing request triggered specific to one piece of selected video information to be pushed and sending the pushing request to the play device according to the IP address so that the play device plays a video corresponding to the video information to be pushed according to the pushing request.

Alternatively, the loading module includes a first sending submodule for starting a preset browser and sending a page request carrying the webpage pushing address to the play device through the browser so that the play device acquires corresponding page information according to the webpage pushing address and returns the page information to a mobile terminal; and a webpage generating submodule for receiving page information returned by the play device, generating a pushing webpage corresponding to the webpage pushing address by adopting the page information and loading the pushing webpage.

Alternatively, the sending module includes a request generating submodule for selecting video information to be pushed and generating a pushing request carrying a pushing instruction and the video information to be pushed according to a set protocol; and a second sending submodule for sending the pushing request to the pre-created server of the set protocol in the play device according to the IP address.

Alternatively, the pushing request is an HTTP request.

According to the apparatus for controlling the play device to play the video provided by the embodiment of the present disclosure, the mobile terminal may acquire an IP address corresponding to the play device and a webpage pushing address by scanning a two-dimensional code displayed on the play device, and then may load a pushing webpage corresponding to the webpage pushing address, wherein the pushing webpage includes a plurality of pieces of video information; when needing to watch the video, a user may select one piece of video information to be pushed for pushing; and the mobile terminal sends a pushing request to the play device according to the IP address so that the play device plays a video corresponding to the video information to be pushed according to the pushing request. As can be known, according to the embodiment of the present disclosure, a relevant client application does not need to be installed in a mobile terminal, therefore, the memory space of the mobile terminal cannot be occupied due to the installation of the application, and in addition, for both a non-smart mobile terminal and a smart mobile terminal, videos can be pushed to the play device, thereby achieving high university.

### Embodiment 5

With reference to FIG. 5, it shows a block diagram of a structure of an apparatus for controlling a play device to play a video Embodiment 5 of the present disclosure;

An apparatus for controlling a play device to play a video of the embodiment of the present disclosure is an apparatus in a play device and includes the following modules:

a displaying module 501 for displaying a two-dimensional code so that a mobile terminal acquires an IP address corresponding to the play device and a webpage pushing address through scanning the two-dimensional code, and loading the pushing webpage corresponding to the webpage pushing address, wherein the pushing webpage includes a plurality of pieces of video information;

a receiving module 502 for receiving a pushing request sent by the mobile terminal, wherein the pushing request is a request acquired by the mobile terminal and triggered specific to one piece of selected video information to be pushed, and is sent to the play device according to the IP address;

a playing module 503 for playing a video corresponding to the video information to be pushed according to the pushing request.

Alternatively, the playing module includes: a request sending submodule for sending the pushing request to a pre-created server of a set protocol in the play device; a request analyzing submodule for analyzing the pushing request according to the set protocol to obtain a pushing instruction and the video information to be pushed, carried in the pushing request; and an instruction responding module for responding to the pushing instruction and starting a preset player to play a video corresponding to the video information to be pushed. Thereunto, the request analyzing submodule and the instruction responding submodule are modules in the server as described above.

Alternatively, the apparatus of the embodiment of the present disclosure also includes: an identifying module for identifying whether a two-dimensional code needs to be regenerated or not when detecting the entry in a two-dimensional code display page before the displaying module displays the two-dimensional code; a generating module generating a new two-dimensional code according to an IP address currently corresponding to the play device and a webpage pushing address when the identifying module identifies that the two-dimensional code needs to be regenerated; an acquiring module for acquiring an original two-dimensional code saved when the identifying module identifies that a two-dimensional code does not need to be regenerated.

According to the embodiment of the present disclosure, a relevant client application does not need to be installed in a mobile terminal, therefore, the memory space of the mobile terminal cannot be occupied due to the installation of the application, and in addition, for both a non-smart mobile terminal and a smart mobile terminal, videos can be pushed to the play device, thereby achieving high university.

Apparatus embodiments are essentially similar to method embodiments and thus are described in a simpler way, and refer to part of the illustration of the method embodiments for the points involved.

The apparatus embodiments described above are illustrative only, wherein the unit described as a separate part may be or may be not physically separated, a part displayed as the unit may be or may be not a physical unit, may be located in one place, or may be distributed on a plurality of network units. Some or all of the modules may be selected to achieve the objective of the solutions of the embodiments according to actual requirements. A person skilled in the art may understand and implement it without undertaking creative works.

Based on the description of the implementation modes above, a person skilled in the art may clearly understand that the implementation modes may be realized by virtue of software and a necessary general-purpose hardware platform, and certainly, by hardware as well. Based on such an understanding, the essential part of the abovementioned technical solutions or the contribution made by the abovementioned technical solutions to the prior art may take the form of a software product, and the computer software product may be stored in a computer-readable storage medium, such as a ROM/RAM, a magnetic disc, an optical disc, and includes a plurality of instructions allowing a computer device (which may be a personal computer, a server, or a network device and the like) to execute each embodiment or the method of some part of the embodiments.

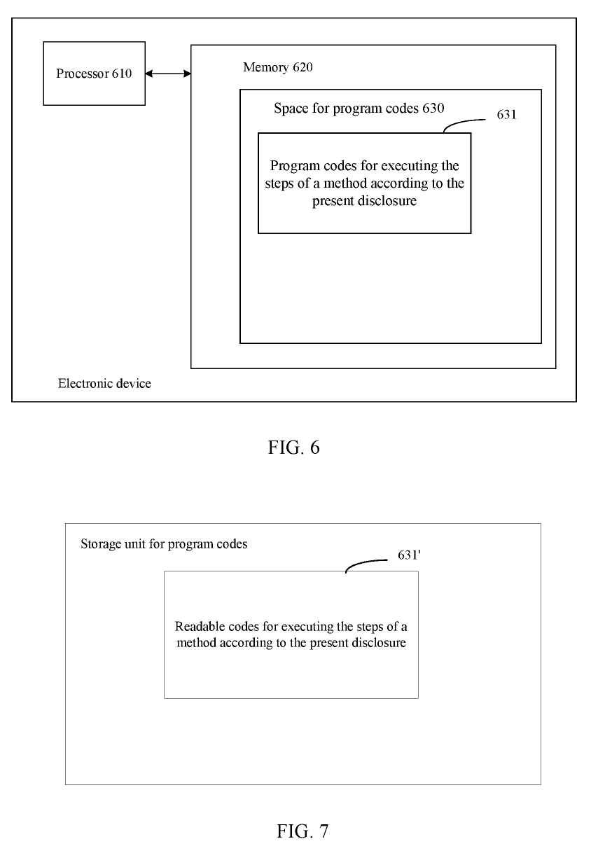

For example, FIG. 6 illustrates a block diagram of an electronic device for executing the method according the disclosure, such as the mobile terminal or play device above. Traditionally, the electronic device includes a processor 610 and a computer program product or a computer readable medium in form of a memory 620. The memory 620 could be electronic memories such as flash memory, EEPROM (Electrically Erasable Programmable Read-Only Memory), EPROM, hard disk or ROM. The memory 620 has a memory space 630 for executing program codes 631 of any steps in the above methods. For example, the memory space 630 for program codes may include respective program codes 631 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 7. The memory cells may be provided with memory sections, memory spaces, etc., similar to the memory 620 of the server as shown in FIG. 6. The program codes may be compressed for example in an appropriate form. Usually, the memory cell includes computer readable codes 631′ which can be read for example by processors 610. When these codes are operated on the server, the server may execute respective steps in the method as described above.

Finally, it should be noted that the foregoing embodiments are merely illustrative of technical solutions of the present disclosure without limitation; although the present disclosure is illustrated in detail with reference to the above embodiments, a person skilled in the art will appreciate that modifications may be made on the technical solutions cited by the above embodiments, or equivalent substitutions may be made on partial technical features; moreover, these modifications or substitutions will not make the essential of corresponding technical solutions depart from the spirit and scope of the technical solutions in respective embodiments of the present disclosure.

What is claimed is:

1. A method for controlling a play device to play a video, comprising:
acquiring an IP address corresponding to the play device and a webpage pushing address by a mobile terminal through scanning a two-dimensional code displayed on the play device;
loading a pushing webpage corresponding to the webpage pushing address by the mobile terminal, wherein the pushing webpage comprises a plurality of pieces of video information;
acquiring a pushing request triggered specific to one piece of selected video information to be pushed and sending the pushing request to the play device according to the IP address, by the mobile terminal, so that the play device plays a video corresponding to the video information to be pushed according to the pushing request.

2. The method according to claim 1, wherein the step of loading a pushing webpage corresponding to the webpage pushing address comprises:
starting a preset browser and sending a page request carrying the webpage pushing address to the play device through the browser so that the play device acquires corresponding page information according to the webpage pushing address and returns the page information to the mobile terminal;
receiving the page information returned by the play device, generating a pushing webpage corresponding to the webpage pushing address by adopting the page information and loading the pushing webpage.

3. The method according to claim 1, wherein the step of acquiring a pushing request triggered specific to one piece of selected video information to be pushed comprises:
selecting one piece of video information to be pushed by the mobile terminal;
generating a pushing request carrying a pushing instruction and the video information to be pushed according to a set protocol;
the step of sending the pushing request to the play device according to the IP address comprises:
sending the pushing request to a pre-created server of the set protocol in the play device according to the IP address.

4. The method according to claim 1, wherein the pushing request is an HTTP request.

5. A method for controlling a play device to play a video, comprising:
displaying a two-dimensional code by the play device so that a mobile terminal acquires an IP address corresponding to the play device and a webpage pushing address through scanning the two-dimensional code, and loading the pushing webpage corresponding to the webpage pushing address, wherein the pushing webpage comprises a plurality of pieces of video information;
receiving a pushing request sent by the mobile terminal by the play device, wherein the pushing request is a request acquired by the mobile terminal and triggered specific to one piece of selected video information to be pushed, and is sent to the play device according to the IP address;
playing a video corresponding to the video information to be pushed according to the pushing request by the play device.

6. The method according to claim 5, wherein the step of playing a video corresponding to the video information to be pushed according to the pushing request comprises:
sending the pushing request to a pre-created server of a set protocol in the play device, and analyzing the pushing request by the server according to the set protocol to obtain a pushing instruction and the video information to be pushed, carried in the pushing request;
responding to the pushing instruction and starting a preset player to play a video corresponding to the video information to be pushed, by the server.

7. The method according to claim 5, wherein before the step of displaying a two-dimensional code by the play device, the method further comprises:
identifying whether a two-dimensional code needs to be regenerated or not when the play device detects the entry in a two-dimensional code display page;
if yes, generating a new two-dimensional code according to an IP address currently corresponding to the play device and a webpage pushing address;
if not, acquiring an original two-dimensional code saved.

8. An electronic device for controlling a play device to play a video, comprising:
at least one first processor; and
a first memory communicably connected with the at least one first processor for storing instructions executable by the at least one first processor, wherein execution of the instructions by the at least one first processor causes the at least one first processor to:
acquire an IP address corresponding to the play device and a webpage pushing address through scanning a two-dimensional code displayed on the play device;
load a pushing webpage corresponding to the webpage pushing address, wherein the pushing webpage comprises a plurality of pieces of video information;
acquire a pushing request triggered specific to one piece of selected video information to be pushed and send the pushing request to the play device according to the IP address, so that the play device plays a video corresponding to the video information to be pushed according to the pushing request.

9. The electronic device according to claim 8, wherein load a pushing webpage corresponding to the webpage pushing address comprises:
starting a preset browser and send a page request carrying the webpage pushing address to the play device through the browser so that the play device acquires corresponding page information according to the webpage pushing address and returns the page information to a mobile terminal;
receiving the page information returned by the play device, generating a pushing webpage corresponding to the webpage pushing address by adopting the page information, and loading the pushing webpage.

10. The electronic device according to claim 8, wherein acquire a pushing request triggered specific to one piece of selected video information to be pushed and send the pushing request to the play device according to the IP address comprises:
selecting one piece of video information to be pushed and generating a pushing request carrying a pushing instruction and the video information to be pushed according to a set protocol;
sending the pushing request to a pre-created server of the set protocol in the play device according to the IP address.

11. The electronic device according to claim 8, wherein the pushing request is an HTTP request.

12. An electronic device, comprising:
at least one second processor; and
a second memory communicably connected with the at least one second processor for storing instructions executable by the at least one second processor, wherein execution of the instructions by the at least one second processor causes the at least one second processor to:
display a two-dimensional code so that a mobile terminal acquires an IP address corresponding to the electronic device and a webpage pushing address through scanning the two-dimensional code, and load the pushing webpage corresponding to the webpage pushing address, wherein the pushing webpage comprises a plurality of pieces of video information;
receive a pushing request sent by the mobile terminal, wherein the pushing request is a request acquired by the mobile terminal and triggered specific to one piece of selected video information to be pushed, and is sent to the electronic device according to the IP address;
play a video corresponding to the video information to be pushed according to the pushing request.

13. The electronic device according to claim 12, wherein play a video corresponding to the video information to be pushed according to the pushing request comprises:
sending the pushing request to a pre-created server of a set protocol in the electronic device;
analyzing the pushing request according to the set protocol to obtain a pushing instruction and the video information to be pushed, carried in the pushing request;
responding to the pushing instruction and starting a preset player to play a video corresponding to the video information to be pushed.

14. The electronic device according to claim 12, wherein execution of the instructions by the at least one processor causes the at least one processor to further:
identify whether a two-dimensional code needs to be regenerated or not when detecting the entry in a two-dimensional code display page before the two-dimensional code is displayed;
generate a new two-dimensional code according to an IP address currently corresponding to the electronic device and a webpage pushing address when it is identified that the two-dimensional code needs to be regenerated;
acquire an original two-dimensional code saved when it is identified that a two-dimensional code does not need to be regenerated.
